(19) United States
(12) Patent Application Publication
(10) Pub. No.: US 2009/0045284 A1
(43) Pub. Date: Feb. 19, 2009

(54) Corded Orientation System For Lighter-Than-Air Aircraft

(76) Inventor: Adam N. Chu, Colorado Springs, CO (US)

Correspondence Address: HANES & SCHUTZ, LLC, 102 SOUTH TEJON ST., SUITE 800, COLORADO SPRINGS, CO, 80903, US

(21) Appl. No.: 11/840,607

(22) Filed: Aug. 17, 2007

(51) Int. Cl. B64B 1/00

(52) U.S. Cl. 244/96

(57) ABSTRACT

An orientation system is disclosed for a lighter-than-air aircraft having a lower stage suspended from an envelope. The orientation system includes cords interconnecting the envelope and the lower stage and means for adjusting the length of at least one of the cords between the lower stage and the envelope. Adjusting the length produces a shift in the angle of attack of the envelope with respect to the lower stage.

### BACKGROUND OF THE INVENTION

Lighter-than-air aircraft take many forms and have a variety of uses. Primary uses for unmanned high altitude lighter-than-air aircraft are for surveillance and communications. Often, it is desirable that these aircraft maintain their position, or station keep.

Traditionally, these high altitude aircraft fly below 70,000 feet. It would be greatly advantageous to fly above 70,000 feet to be above atmospheric turbulence and disruptive weather, and to de-conflict from commercial, private, and military fixed wing aircraft . . . . However, at altitudes above 70,000 feet, strong winds are present. In order to station keep in these strong winds, it is highly useful for the aircraft to have an effective orientation system.

### DESCRIPTION OF THE DRAWINGS

FIG. 1 is a perspective view of one example of a lighter-than-air aircraft upon which the present invention orientation system may be used.

FIG. 2 is an enlarged perspective view of the lower stage shown in FIG. 1.

FIG. 3 is an enlarged perspective view of one embodiment of the present invention orientation system for a lighter-than-air aircraft.

FIG. 4 is a side elevation of one embodiment of the present invention orientation system for a lighter-than-air aircraft.

FIG. 5 is a top elevation of one embodiment of the present invention orientation system for a lighter-than-air aircraft.

FIGS. 6-8 illustrate the operation of one embodiment of the present invention orientation system for a lighter-than-air aircraft.

FIG. 9 is a flow chart showing one embodiment of a method for orienting a lighter-than-air aircraft.

FIG. 10 is an exploded perspective view of one embodiment of a swivel for use with one embodiment of the present invention orientation system for a lighter-than-air aircraft.

FIG. 11 is a side elevation of the swivel of FIG. 10.

FIGS. 12-18 illustrate the operation of one embodiment of the present invention orientation system for a lighter-than-air aircraft.

FIG. 19 is a flow chart showing one embodiment of a method for orienting a lighter-than-air aircraft.

### DETAILED DESCRIPTION OF THE INVENTION

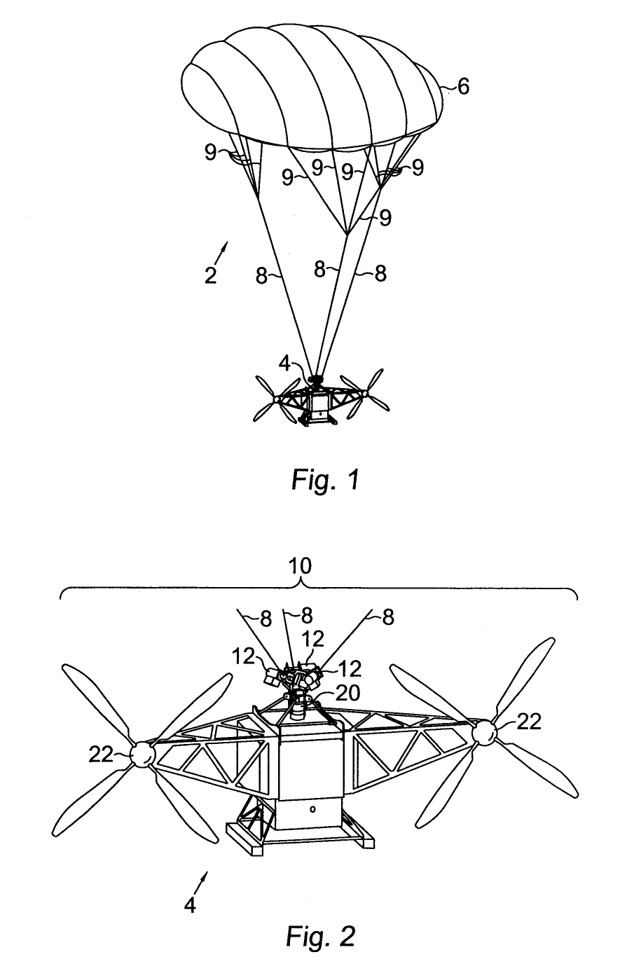

FIG. 1 shows one example of a lighter-than-air aircraft 2 upon which the present invention orientation system may be used. Aircraft 2 includes a lower stage 4 suspended from envelope 6 by cords 8.

Lower stage 4 is any structure suspended from envelope 6. Although FIG. 1 shows one type of lower stage 4, other types of lower stage 4 are contemplated for use with this invention. In some embodiments, lower stage 4 includes a propulsion system, a navigation system, and a payload.

Envelope 6 is any type of envelope for use with a lighter-than-air aircraft 2. Although FIG. 1 shows one type of envelope 6, other types of envelopes 6 are contemplated for use with this invention.

Cords 8 are any type of cords suitable for suspending lower stage 4 from envelope 6. Examples of cords 8 include cables, ropes, and straps. FIG. 1 illustrates one embodiment of cords 8 wherein three cords 8 are attached to lower stage 4. These three cords 8 are also connected to points near the perimeter of envelope 6. Although FIG. 1 shows that these three cords 8 are connected to the perimeter points through other intermediate cords 9, cords 8 may alternatively be directly connected to the points near the perimeter of envelope 6. Additionally, the number of cords 8 need not be exactly three, as shown in FIG. 1, other quantities of cords 8 are contemplated by and within the scope of this invention.

FIG. 2 is enlarged perspective view of the lower stage shown in FIG. 1. Illustrated in FIG. 2 is a perspective view of one embodiment of the present invention orientation system 10 for lighter-than-air aircraft 2.

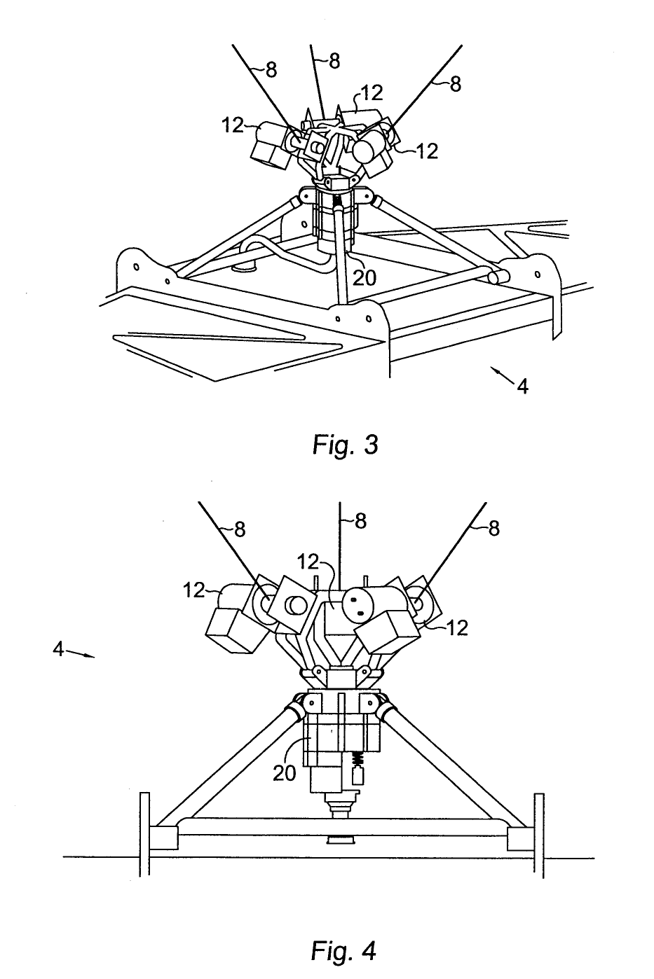

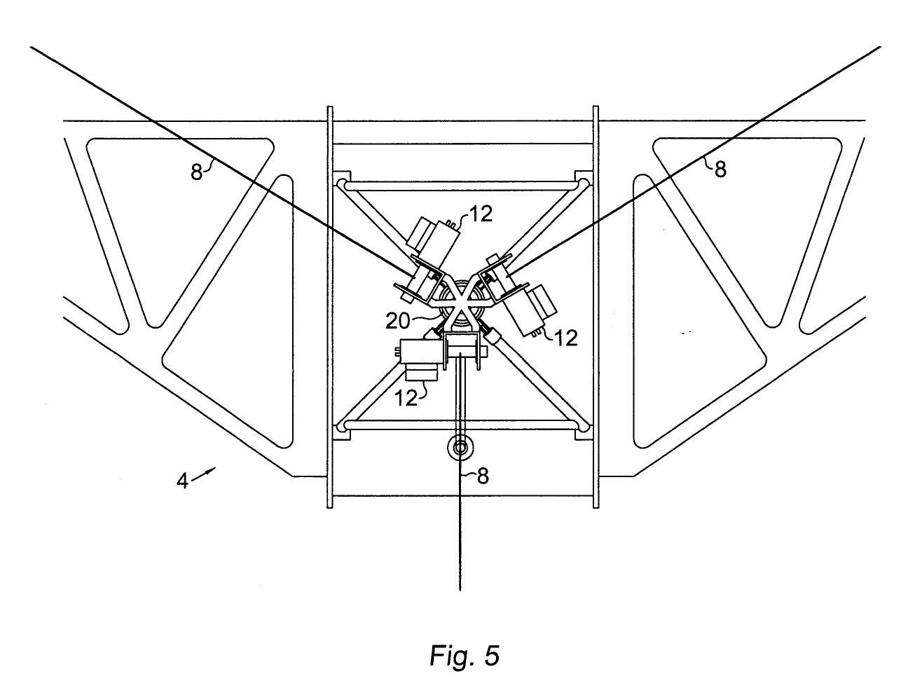

FIGS. 3-5 show enlarged views of one embodiment of the present invention orientation system 10 for lighter-than-air aircraft 2. In one embodiment, orientation system 10 includes cords 8 and at least one winch 12.

Each cord 8 is spooled onto a winch 12 and each winch 12 is attached to one of the cords 8 such that each winch 12 is able to reel in and pay out cord 8 to adjust the length of cord 8 between lower stage 4 and envelope 6. While the present invention is described using the terms winch and winches, other means for adjusting the length of cords 8 between lower stage 4 and envelope 6 may alternatively be used in place of winches 12. Adjusting the length of cords 8 between lower stage 4 and envelope 6 produces a shift in the angle of attack of envelope 6 with respect to lower stage 4.

In one embodiment, winches 12 are attached to lower stage 4 between lower stage 4 and envelope 6. Alternatively, winches 12 may be attached elsewhere, so long as winches 8 function to adjusting the length of cords 8 between lower stage 4 and envelope 6.

In one embodiment, winches 12 dissimilarly adjust the length of cords 8. That is, at least one of the winches 12 operates in an opposite direction to at least another one of the winches 12 or at least one of the winches 12 does not operate while at least another one of the winches 12 operates to either reel in or pay out its cord 8. For example, at least one of the winches 12 reels in its cord 8 and at least another one of the winches 12 pays out its cord 8. In another example, at least one winch 12 reels in or pays out it cord 8 and at least another one of the winches 12 maintains the length of it cord 8 between lower stage 4 and envelope 6.

The Figures illustrate one embodiment of winches 12 wherein three winches 12 are attached to lower stage 4. Alternatively, the number of winches 12 need not be exactly three, as shown in the Figures, other quantities of winches 12 are contemplated by and within the scope of this invention.

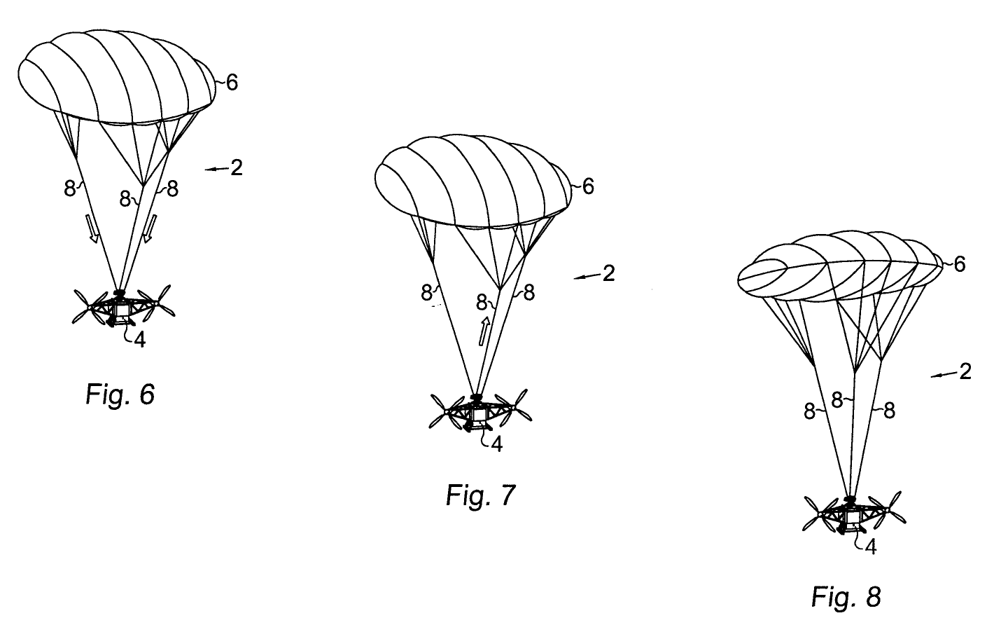

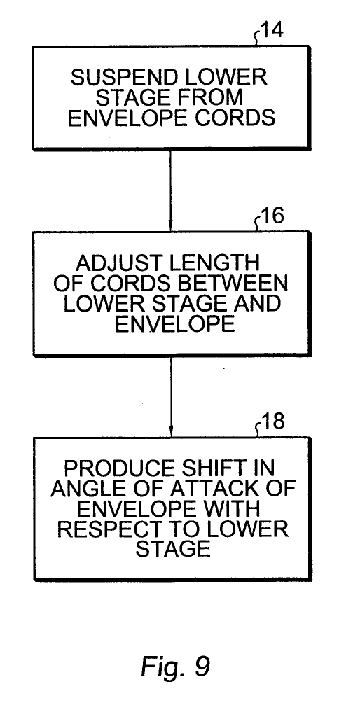

FIGS. 6-8 illustrate one embodiment of the method of the present invention system and method for orienting aircraft 2. FIG. 9 is a flow chart representing steps of one embodiment of the present invention. Although the steps represented in FIG. 9 are presented in a specific order, the present invention encompasses variations in the order of steps. Furthermore, additional steps may be executed between the steps illustrated in FIG. 9 without departing from the scope of the present invention.

Lower stage 4 is suspended 14 from envelope 6 with a plurality of cords 8. The length of at least one of the cords 8 between lower stage 4 and envelope 6 is adjusted 16. In one embodiment, adjusting 16 the length of at least one of the cords 8 includes dissimilarly adjusting 16 the length of a plurality of the cords 8. In another embodiment, dissimilarly adjusting 16 the length includes adjusting 16 the length in an opposite direction. FIGS. 6 and 7 illustrate two aft cords 8 being reeled in and a forward cord 8 being paid out.

Adjusting 16 the length of at least one of the cords 8 between lower stage 4 and envelope 6 produces 18 a shift in the angle of attack of envelope 6 with respect to lower stage 4. FIG. 8 illustrates an increase in the angle of attack of envelope 6 with respect to lower stage 4. While FIGS. 6-8 illustrate one embodiment for changing the angle of attack of envelope 6 with respect to lower stage 4, other embodiments wherein other combinations of cords 8 are dissimilarly adjusted are also contemplated by and included within the scope of the present invention.

Referring again to FIGS. 2-5, in another embodiment, orientation system 10 includes a swivel 20 and a plurality of thrust generators 22.

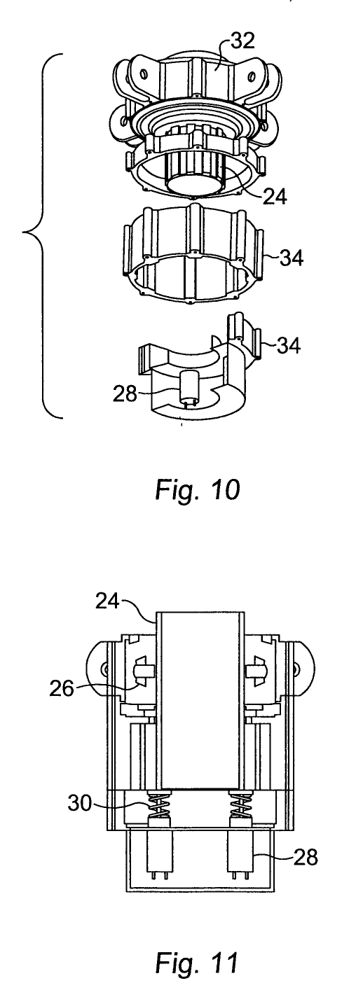

Swivel 20 is affixed between envelope 6 and lower stage 4 and is oriented for allowing lower stage 4 to rotate with respect to envelope 6. FIGS. 10 and 11 illustrate one embodiment of a suitable swivel 20. Other types of swivels 20 are also suitable.

In one embodiment, swivel 20 includes shaft 24, bearing 26, solenoids 28, return springs 30, hub 32, and clutch 34. Clutch 34 is any device or means for locking and unlocking swivel 20 in order to allow or prohibit rotation of lower stage 4 with respect to envelope 6. Hub 32 and bearing 26 hold shaft 24. solenoids 28 and return springs 30 operate clutch. The operation of swivels 20 such as those illustrated in FIGS. 10 and 11 are well known and, for that reason, will not be described here in further detail.

Thrust generators 22 are any suitable device for generating thrust. In one embodiment, thrust generators 22 are propellers.

Additionally, the Figures illustrate one embodiment of thrust generators 22 wherein two thrust generators 22 are attached to lower stage 4. Alternatively, the number of thrust generators 22 need not be exactly two, as shown in the Figures, other quantities of thrust generators 22 are contemplated by and within the scope of this invention.

Thrust generators 22 may be affixed anywhere on lower stage 4 so long as at least some of the trust generators 22 generating differential thrust produces a change in rotation of lower stage 4 with respect to envelope 6. In one embodiment, thrust generators 22 are affixed to opposing sides of lower stage 4 and are oriented to produce parallel trust streams.

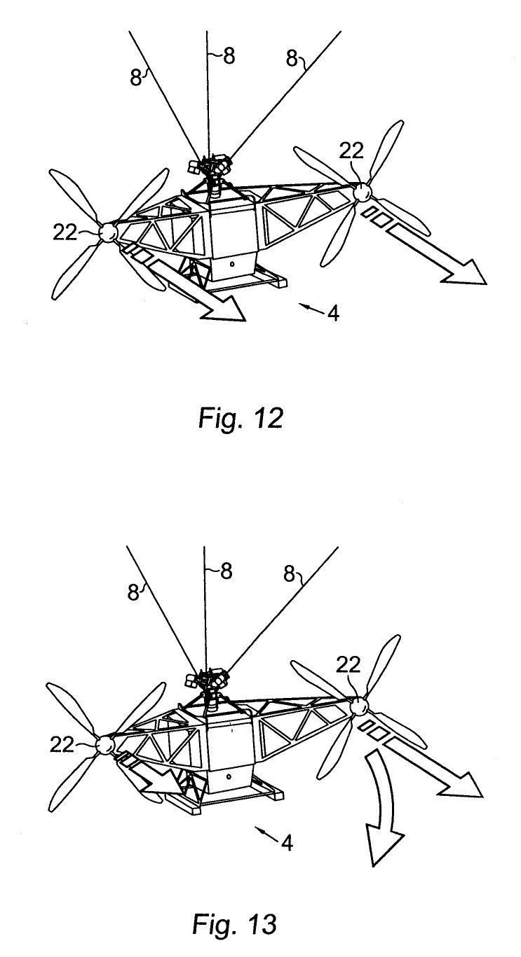

FIGS. 12-18 illustrate one embodiment of the method of the present invention system and method for orienting aircraft 2. FIG. 19 is a flow chart representing steps of one embodiment of the present invention. Although the steps represented in FIG. 19 are presented in a specific order, the present invention encompasses variations in the order of steps. Furthermore, additional steps may be executed between the steps illustrated in FIG. 10 without departing from the scope of the present invention.

FIG. 12 illustrates lower stage 4 in a normal position. The thrust from trust generators 22 is balanced and swivel 20 is locked.

Swivel 20 is unlocked 36. Thrust generators 22 generate 38 differential thrust. FIG. 13 illustrates thrust from one of the thrust generators 22 being reduced.

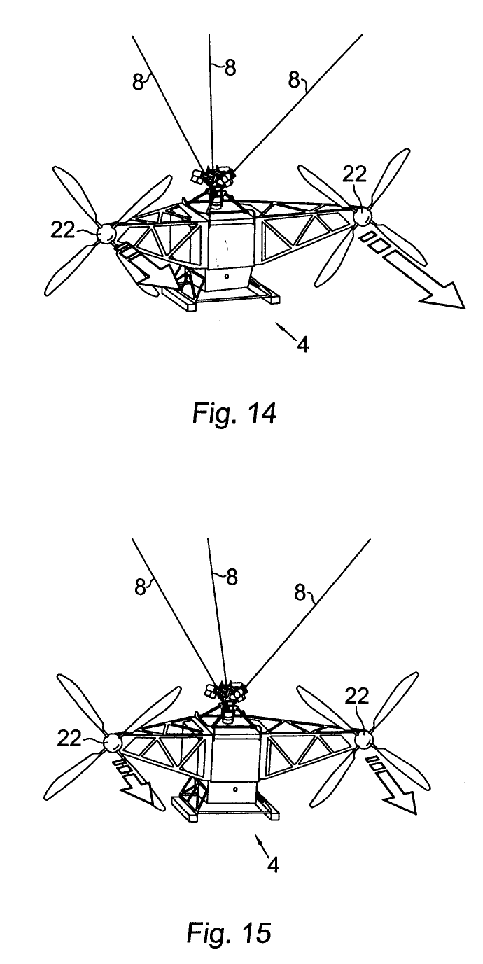

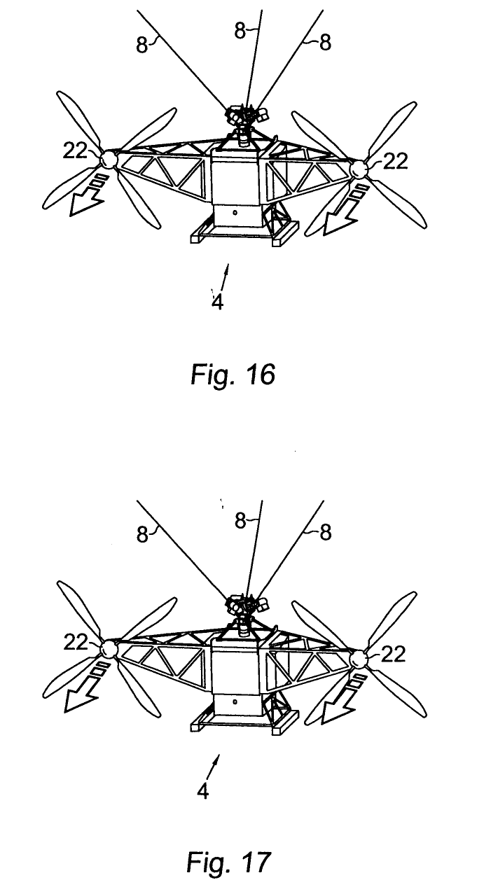

The differential thrust is allowed to rotate 40 lower stage 4 with respect to envelope 6. FIGS. 14-15 illustrates the differential thrust rotating lower 4 with respect to envelope 8. FIG. 16 illustrates thrust from the reduced thrust generator 22 being increased as lower stage 4 approaches the desired orientation. FIG. 17 illustrates a renewed balance of trust from thrust generators 22.

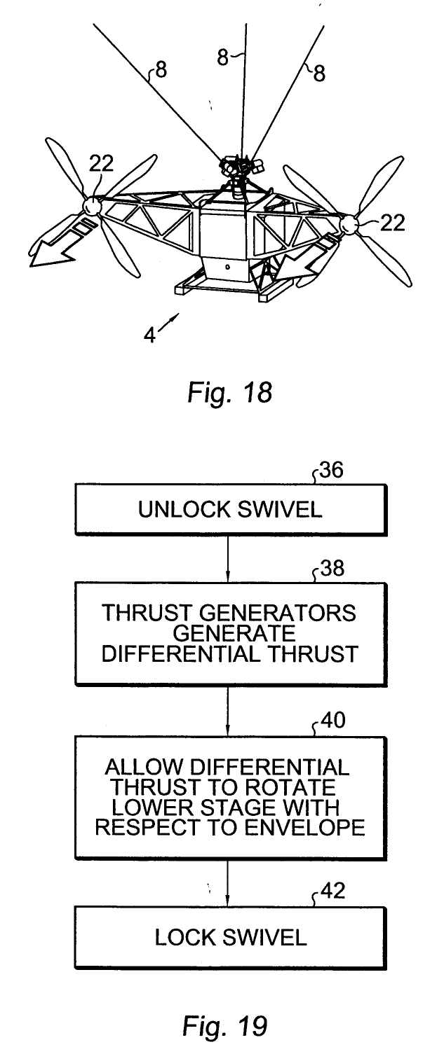

Swivel 20 is locked 42. Swivel 42 may be locked 42 gradually, or all at once. FIG. 18 illustrates lower stage 4 in the new normal position with swivel 20 locked and the thrust balanced.

The foregoing description is only illustrative of the invention. Various alternatives, modifications, and variances can be devised by those skilled in the art without departing from the invention. Accordingly, the present invention embraces all such alternatives, modifications, and variances that fall within the scope of the described invention.

What is claimed is:

1. An orientation system for a lighter-than-air aircraft having a lower stage suspended from an envelope, the orientation system comprising:
a plurality of cords interconnecting the envelope and the lower stage and
means for adjusting the length of at least one of the cords between the lower stage and the envelope, wherein adjusting the length produces a shift in the angle of attack of the envelope with respect to the lower stage.

2. The orientation system of claim 1 wherein the means for adjusting the length of at least one of the cords includes at least one winch affixed to at least one of the cords, the winch configured to shorten and lengthen a length of the affixed cord between the envelope and the lower stage.

3. The orientation system of claim 1 wherein the means for adjusting the length of at least one of the cords includes means for dissimilarly adjusting the length of a plurality of the cords.

4. The orientation system of claim 1 wherein the plurality of cords includes at least three cords and wherein the means for adjusting the length of at least one of the cords includes at least three winches, each of the winches affixed to one of the cords, each winch configured to shorten and lengthen a length of the affixed cord between the envelope and the lower stage.

5. The orientation system of claim 4 wherein at least one of the winches is configured to operate in an opposite direction to the other winches, either shortening or lengthening the length of the cord while the other winches either lengthen or shorten, respectively, the length of the other cords.

6. The orientation system of claim 1 wherein the plurality of cords are connected to points near an outside perimeter of the envelope.

7. An orientation system for a lighter-than-air aircraft having a lower stage suspended from an envelope, the orientation system comprising:
at least two winches affixed to the lower stage
at least three cords affixed to the envelope, each cord spooled onto one of the winches, wherein dissimilarly operating the winches to adjust the length of the cords between the envelope and the lower stage produces a shift in the angle of attack of the envelope with respect to the lower stage.

8. The orientation system of claim 7 wherein at least one of the winches is configured to operate in an opposite direction to another of the winches, either shortening or lengthening the length of cord while the other of the winches either lengthens or shortens the length of cord, respectively.

9. The orientation system of claim 7 wherein the at least three cords are connected to points near an outside perimeter of the envelope.

10. A method for orienting a lighter-than-air aircraft having a lower stage suspended from an envelope, the method comprising:
suspending the lower stage from the envelope with a plurality of cords
adjusting the length of at least one of the cords between the lower stage and the envelope, wherein adjusting the length produces a shift in the angle of attack of the envelope with respect to the lower stage.

11. The method of claim 10 wherein the adjusting the length of at least one of the cords includes dissimilarly adjusting the length of a plurality of the cords.

12. The method of claim 11 dissimilarly adjusting the length includes adjusting the length in an opposite direction.
